(19) United States
(12) Patent Application Publication
(10) Pub. No.: US 2015/0309631 A1
(43) Pub. Date: Oct. 29, 2015

(54) TOUCH PANEL AND MANUFACTURING METHOD THEREOF

(71) Applicant: BOE TECHNOLOGY GROUP CO., LTD., Beijing (CN)

(72) Inventors: Can WANG, Beijing (CN); Ning CHEN, Beijing (CN); Wei GUO, Beijing (CN); Lu WANG, Beijing (CN)

(73) Assignee: BOE TECHNOLOGY GROUP CO., LTD., Beijing (CN)

(21) Appl. No.: 14/407,765

(22) PCT Filed: May 28, 2014
(86) PCT No.: PCT/CN2014/078706

§ 371 Date: Dec. 12, 2014

(30) Foreign Application Priority Data
Nov. 8, 2013 (CN) 201310553467.4

(51) Int. Cl. G06F 3/041; G06F 1/16; G06F 3/044

(52) U.S. Cl. CPC G06F 3/0412; G06F 3/044; G06F 1/16; G06F 2203/04103; G06F 2203/04107

(57) ABSTRACT

A touch panel and a manufacturing method thereof are provided. The touch panel comprises touch electrodes (14), an insulating layer (15) is disposed above or below the level where the touch electrodes (14) are located, or insulating layers (15) are disposed above and below the level where the touch electrodes (14) are located. With the touch panel, short-circuit and open-circuit issue that is very easy to occur during formation of the touch electrodes (14) can be avoided, thereby enhancing the yield and reducing the cost.

### TECHNICAL FIELD

Embodiments of the present invention relate to a touch panel and a manufacturing method thereof.

### BACKGROUND

Touch panel displays have been developed rapidly. Many products adopt the structural design of an add-on touch panel, but the overall structure of the add-on touch panel is thick and heavy, and the cost is relatively high. As the consumer's demand for light-weight and thin profile of displays increases, in-cell liquid crystal panels have become the important developing trend in the field of touch display.

In the structure of an in-cell touch display panel, touch electrodes are produced on a color filter substrate. During manufacture, the pattern of a black matrix is formed firstly by a conventional process, and then wiring of the touch electrodes is prepared in the shielding region of the black matrix. The working process of the touch display panel is as follows. When touch scanning signals are applied to the touch electrodes working as touch scanning lines, voltage signals can be generated through coupling on the touch sensing lines by means of sensing capacitors. In this course, if a user contacts the touch panel, then the human body's electric field will act on the sensing capacitors between the touch scanning lines and the touch sensing lines, so that capacitances of the sensing capacitors change, and in turn, the voltage signals generated on the touch sensing lines through coupling change as well. The coupled voltage signals are detected by a touch detection device, and a touch position can be determined based on the change of the voltage signals.

### SUMMARY

According to at least one embodiment of the present invention, there are provided a touch panel and a manufacturing method thereof, capable of avoiding such an issue that short circuit and open circuit are very easy to happen to touch electrodes during formation, so as to improve the yield and reduce the cost.

According to at least one embodiment of the invention, there is provided a touch panel that comprises touch electrodes, an insulating layer is disposed above or below the level where the touch electrodes are located, or insulating layers are respectively disposed above and below the level where the touch electrodes are located.

According to at least another embodiment of the invention, there is provided a manufacturing method of a touch panel that comprises forming a counter substrate. Forming the color filter substrate comprises forming a black matrix on a substrate; forming an insulating layer on the substrate with the black matrix provided thereon; forming touch electrodes on the insulating layer; forming an overcoat layer.

According to at least still another embodiment of the invention, there is provided a manufacturing method of a touch panel that comprises forming a counter substrate. Forming the color filter substrate comprises forming a black matrix on a substrate; forming touch electrodes; forming an insulating layer on the substrate with the touch electrodes provided thereon; forming an overcoat on the insulating layer.

### BRIEF DESCRIPTION OF THE DRAWINGS

In order to illustrate the technical solution of the embodiments of the invention more clearly, the drawings of the embodiments will be briefly described below; it is obvious that the drawings as described below are only related to some embodiments of the invention, but not limitative of the invention.

FIG. 1(a) and FIG. 1(b) are structurally schematic views illustrating color filter substrates provided by an embodiment of the invention;

FIG. 2 is a structurally schematic view illustrating a touch panel provided by an embodiment of the invention;

FIG. 3 is a structurally schematic view illustrating a black matrix and color filter units in an embodiment of the invention;

FIG. 4 is a structurally schematic view illustrating touch electrodes in an embodiment of the invention;

FIG. 5(a) and FIG. 5(b) are schematic views illustrating a detection location and lead wires for touch electrodes at an edge of a color filter substrate in a test according to an embodiment of the invention, respectively;

FIG. 6(a) and FIG. 6(b) are schematic views illustrating test results for a touch electrode 1 and a touch electrode 2 in a test according to an embodiment of the invention, respectively;

FIG. 7 is a schematic view illustrating a test result for a touch electrode 3 in a test according to an embodiment of the invention; and

FIG. 8 is a second flowchart illustrating a manufacturing method of a color filter substrate provided by an embodiment of the invention.

### REFERENCE NUMERALS

10—substrate; 121—black matrix; 122—color filter;
13—insulating layer; 14—touch electrode;
15—overcoat layer; 16—spacer

### DETAILED DESCRIPTION

In order to make objects, technical details and advantages of the embodiments of the invention apparent, hereinafter, the technical solutions of the embodiments of the invention will be described in a clearly and fully understandable way in connection with the drawings related to the embodiments of the invention. It is obvious that the described embodiments are just a part but not all of the embodiments of the invention. Based on the described embodiments of the invention, those ordinarily skilled in the art can obtain other embodiment(s), without any inventive work, which should be within the scope sought for protection by the invention.

Unless otherwise defined, the technical terminology or scientific terminology used herein should have the same meaning as commonly understood by one of ordinary skill in the art to which this invention belongs. “First”, “second” and the like used in specification and claims of the patent application of the invention do not show any order, number or importance, but are only used to distinguish different constituent parts. Likewise, a term “a,” “an,” or the like does not indicate limitation in number, but specifies the presence of at least one. A term “comprises,” “comprising,” “includes,” “including” or the like means that an element or article ahead of this term encompasses element(s) or article(s) listed behind this term and equivalents thereof, but does not preclude the presence of other elements or articles. A term “connection,” “connected,” or the like is not limited to physical or mechanical connection, but can include electrical connection, whether directly or indirectly. “Upper,” “lower,” “left,” “right” or the like is only used to describe a relative positional relationship, and when an absolute position of the described object is changed, the relative positional relationship might also be changed accordingly.

According to at least one embodiment of the invention, there is provided a touch panel that includes touch electrodes, an insulating layer is disposed above or below the level where the touch electrodes are located, or insulating layers are respectively disposed above and below the level where the touch electrodes are located. The insulating layer(s) can act to isolate the level where the touch electrodes are located from structural layer(s) to be etched with an etching solution, and for example, the insulating layer isolates the touch electrodes from a structural layer formed with a negative photoresist. Examples of the structural layers formed with a negative photoresist include a black matrix, an overcoat layer, a spacer layer and so on, and for example, a negative photoresist layer that has been exposed is etched (developed) with an alkaline etching solution during a formation process so as to obtain a desired pattern. The insulating layer disposed above or below the level where the touch electrodes are located as stated above can avoid the touch electrodes from being adversely affected by the alkaline etching solution, and plays the role of chemical insulation. For example, an insulating layer in direct contact with (directly adjacent to) the touch electrodes is disposed above or below the level where the touch electrodes are located.

In a touch screen, touch electrodes usually include touch driving electrodes (touch scanning lines) and touch sensing electrodes (touch sensing lines), and sensing (coupling) capacitors can be formed between the touch driving electrodes and the touch sensing electrodes. In the course of applying touch scanning signals to the touch driving electrodes, when a finger (or other object, such as a touch pen) gets close to or contacts the touch panel, the sensing signal on a touch sensing electrode adjacent to a touch point will be affected. The location of the touch point can be identified by means of detecting sensing signals on touch sensing electrodes.

In an in-cell touch panel, touch sensing electrodes are provided on a color filter substrate, and touch driving electrodes are provided on an array substrate. As for this kind of touch panel, upon formation of the color filter substrate, the pattern of a black matrix may be formed firstly in a conventional process; next, the wiring of touch electrodes is provided in the shielding region of the black matrix; and at last, an overcoat (OC) layer and photo spacers (PS) are formed. As found by the inventors, an issue that touch electrodes are short-circuited and open-circuited is very easy to occur during this course, leading to a low yield. Moreover, it is also found by the inventors that short-circuit and open-circuit problems has a direct connection with the process for upper and lower layers of the level where the touch electrodes are located. For example, when a black matrix under the touch electrodes is formed, and when an overcoat layer or photo spacers above the touch electrodes are formed, a negative photoresist is used as one of the forming materials, the developing solution used for development of the exposed negative photoresist is KOH developing solution (an alkaline developing solution), and this is the key reason why short-circuit and open-circuit problems is easy to occur in the course of forming the touch electrodes.

With respect to the touch panel provided by the embodiment, an improvement is made to the upper-level/lower-level process with respect to touch electrodes, i.e., an insulating layer is disposed above or below the level where the touch electrodes are located or insulating layers are respectively disposed above and below the level where the touch electrodes are located, so that the level where the touch electrodes are located is isolated from a negative photoresist layer that may cause the adverse problems, and the disadvantageous effects of the etching solution is avoided. Thus, the issue that short-circuit and open circuit are very easy to occur to touch electrodes during the formation is overcome (which has been verified by experiments, and please see Embodiment 2 for the experimental data), realization of a touch function of touch electrodes on a color filter substrate is assured. It is possible that the yield is enhanced, and the production cost is reduced.

In some embodiments of the invention, the touch electrodes may be touch driving electrodes or may be touch sensing electrodes. In an in-cell touch screen scheme, for example, touch sensing electrodes are provided on a color filter substrate, and touch driving electrodes are provided on an array substrate. Therefore, it is possible that an insulating layer is disposed above or below the level where touch sensing electrodes are located on the color filter substrate, or insulating layers are respectively disposed above and below the level where touch electrodes are located.

In the above embodiments, the color filter substrate is an example of a counter substrate in a display screen that is disposed opposite to an array substrate. When the array substrate is a COA (Color-filter on Array) substrate, the counter substrate may include a black matrix but a color filter layer is not necessary to be formed thereon any more. Further, in at least one embodiment of the invention, the array substrate includes a color filter layer and a black matrix, and accordingly, the counter substrate that is disposed opposite to the array substrate to form a liquid crystal cell may not include a color filter layer and a black matrix.

As shown in FIG. 2, in at least one touch display device according to embodiments of the invention, an array substrate 2 and a counter substrate 3 are disposed opposite to each other and bonded together with sealant 6 to form a liquid crystal cell 1, in which a liquid crystal material 4 is filled. An example of the counter substrate 3 is a color filter substrate (e.g., the color filter substrate 20 in the above embodiments). A pixel electrode for each sub-pixel unit of the array substrate 2 serves to apply an electric field for control of the degree of rotation of the liquid crystal material, so as to perform a display operation. In some examples, the touch display device further includes a backlight source 5 for providing the array substrate with backlight.

Embodiments of the invention do not limit the positions of touch driving electrodes and touch sensing electrodes, and as long as the short-circuit and open-circuit issue happens to touch driving electrodes or touch sensing electrodes due to upper-level/lower-level process, technical solutions provided by embodiments of the invention are applicable.

For example, the insulating layer is an inorganic insulating layer, capable of isolating a chemical etching solution so as to avoid its adverse effect upon the level where touch electrodes are located. For example, the substance for the inorganic the insulating layer may be silicon nitride, silicon oxide, silicon oxynitride or the like, or a combination of these substances. The insulating layer may have a single-layered structure or a multilayered (laminated) structure.

In order that those skilled in the art better understand the structure of the touch panel provided by embodiments of the invention, detailed descriptions will be given below with reference to a concrete example.

The touch panel according to an embodiment includes a color filter substrate and an array substrate, which are disposed opposite to each other to form a liquid crystal cell with a liquid crystal material being filled therein. Touch sensing electrodes are provided on the color filter substrate, and touch driving electrodes are provided on the array substrate.

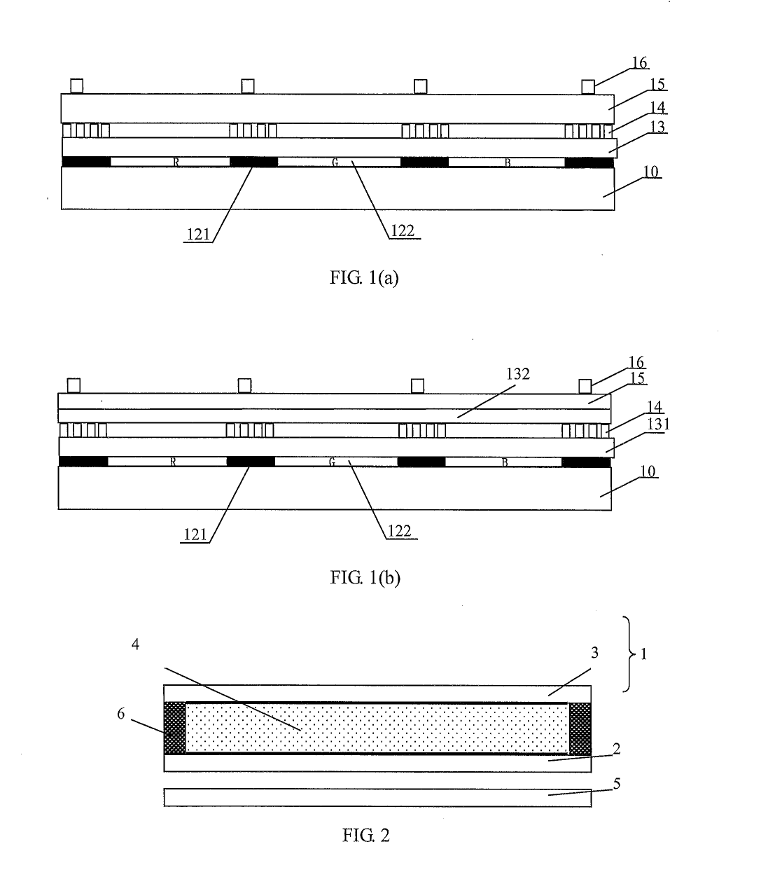

The structure and manufacturing process of the array substrate may adopt a known structure and a known manufacturing process, and details are omitted and no limitation will be made here. In accordance with at least one embodiment of the invention, the structure of a color filter substrate of a touch display panel is shown in FIG. 1(a), and includes a substrate 10 and a color filter layer provided on the substrate 10. The substrate 10 may be a glass substrate, a plastic substrate or the like. The color filter layer includes a black matrix 121 and color filter units 122 provided in openings of the black matrix 121. An insulating layer 13 is disposed on the color filter layer and at least covers the black matrix 121. Touch electrodes 14 are disposed on the black matrix 121, and are located corresponding to the shielding location of the black matrix 121, that is, in the direction perpendicular to a surface of the substrate 10, the projection of the touch electrodes 14 are situated within the projection of the black matrix 121. An overcoat layer 15 is disposed on the level where the touch electrodes 14 are located, and for example, it covers the touch electrodes. For example, spacers 16, such as, post spacers fabricated by a photosensitive material may be further provided over the overcoat layer 15, so as to maintain the spacing between the color filter substrate and the array substrate.

In the example, the touch electrodes 14 are touch sensing electrodes.

The insulating layer 13 located under the touch electrodes as stated above may also be located over the level where the touch electrodes 14 are located, and for example, it is located between the level where the touch electrodes 14 are located and the overcoat layer 15.

According to at least one embodiment of the invention, the structure of a color filter substrate of a touch display panel is shown in FIG. 1(b), and includes a substrate 10 and the a color filter layer provided on the substrate 10. The color filter layer includes a black matrix 121 and color filter units 122 located in openings of the black matrix 121. A first insulating layer 13s is disposed on the color filter layer. Touch electrodes 14 are disposed on the black matrix 121, and are located corresponding to the shielding location of the black matrix 121. A second insulating layer 132 is disposed on the touch electrodes 14, and for example, it covers the touch electrodes 14. An overcoat layer 15 is disposed over the second insulating layer 132. For example, spacers 16 may be further provided on the overcoat layer 15.

In the touch panel provided by the embodiment, an insulating layer is above and/or below the level where touch electrodes are located, isolating the upper and lower layers that may cause problems. Thus, the issue that short circuit and open circuit are very easy to occur to the touch electrodes during the formation is avoided, and the realization of a touch function of the touch electrodes is assured. It is possible that the yield is improved, and the production cost is reduced.

The touch panel provided by the embodiment is applicable to liquid crystal panels, electronic papers, OLED panels, cell phones, tablet computers, televisions, displays, notebook computers, digital photo frames, navigators or any other product or component having a display function.

According to at least one embodiment of the invention, there is further provided a manufacturing method of a touch panel, which includes forming a color filter substrate. As shown in FIG. 8, an example of forming the color filter substrate includes the following steps.

101, a color filter layer is formed on a substrate.

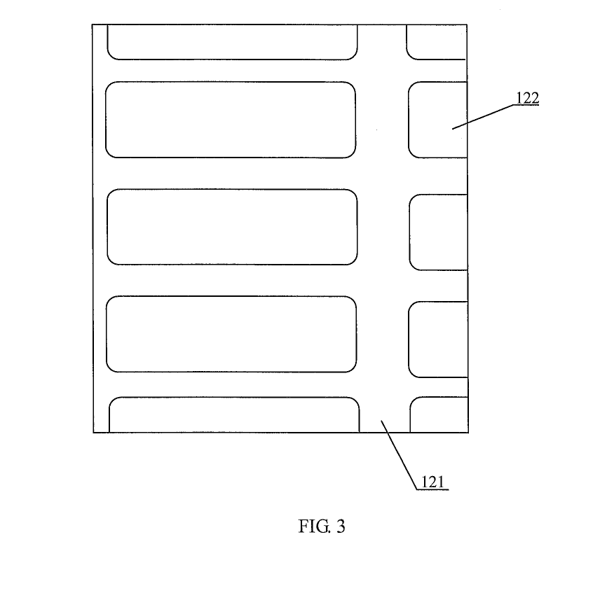

The substrate may be a glass substrate, a plastic substrate or the like. The color filter layer formed by the step, as shown in FIG. 3, includes a black matrix 121 and color filter units 122 separated by the black matrix 121, and the color filter units 122 are provided in openings of the black matrix 121. The color filter units 122 may be for example red, green and blue (RGB) color filter substrates, but are not limited to this combination of primary colors. This step can be performed in any way known by those skilled in the art, and the invention is not limited thereto.

For example, it is possible that a black matrix is formed firstly (e.g., a black photoresist is used to form the black matrix); and then a variety of color filter units are formed sequentially. In at least another embodiment of the invention, the step of forming color filter units may be arranged to be subsequent to a step 103 of forming touch electrodes, that is, it proceeds in the following order: forming a black matrix; forming an insulating layer; forming touch electrodes; forming color filter units; forming spacers.

102, an insulating layer is formed on the substrate with the color filter layer provided thereon.

A transparent insulating layer is formed on the color filter layer, and its material may be any transparent insulating material known by those skilled in the art. For example, the insulating layer may be an inorganic insulating layer, and the substance of the inorganic insulating layer may be silicon nitride, silicon oxide, silicon oxynitride, or any combination of these materials.

For example, in this step that, a silicon nitride layer may be deposited at a low temperature (not higher than 230° C.) to form the insulating layer.

103, touch electrodes are formed on the insulating layer.

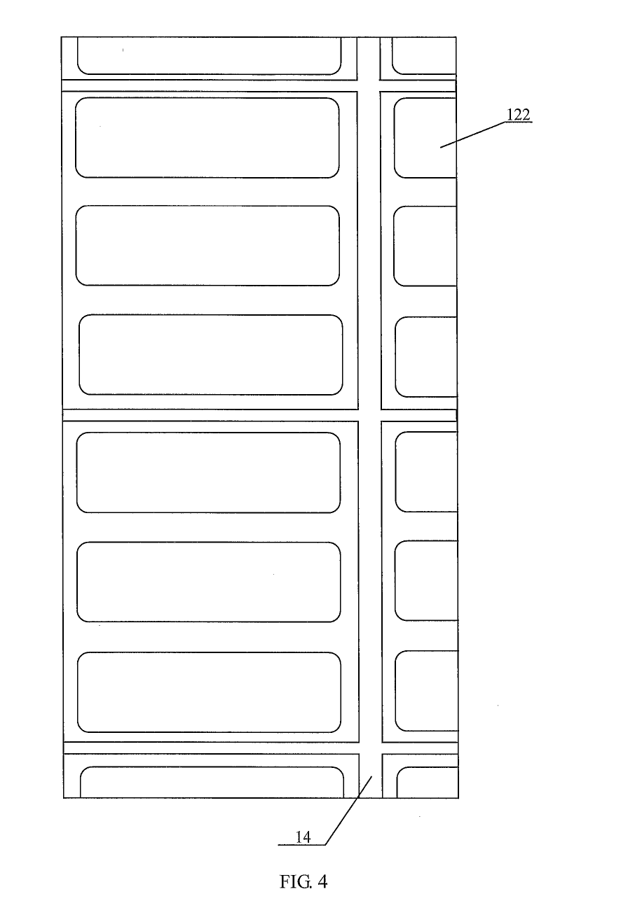

An example of forming the touch electrodes on the insulating layer includes depositing of an electrode layer, exposing, etching and other sub-steps, and touch electrodes 14 as shown in FIG. 4 are formed at the shielding location of the black matrix.

104, an overcoat layer and spacers are formed.

For example, with the processes of photoresist coating, exposing, developing and other steps, spacers are formed with a photoresist material.

An insulating layer may further be disposed over the level where the touch electrodes are located. That is, in a second example of the embodiment, the process of the color filter substrate may include forming a color filter layer on a substrate; forming touch electrodes; forming an insulating layer on the substrate with the touch electrodes provided thereon; forming an overcoat layer and spacers on the insulating layer.

Obviously, the method of the second example as stated above differs from the first example in that, in the specific implementation, the insulating layer is formed after formation of the touch electrodes.

In addition, in a third example of the embodiment, insulating layers are respectively disposed above and below the level where the touch electrodes are located. In this case, the process flow is as follows: forming a black matrix; forming color filter units; forming a first insulating layer (e.g., SiNx); forming touch electrodes; forming a second insulating layer (e.g., SiNx); forming an overcoat layer; forming spacers.

For example, as shown in FIG. 8, in at least one embodiment of the invention, in addition to the above steps, the manufacturing method of the touch panel may further include the following steps.

105, etching is conducted on the insulating layer with a dry-etch equipment, so as to expose connecting regions for connection with an array substrate.

When the first insulating layer and the second insulating layer are formed under and over the touch electrodes, respectively, the first insulating layer and the second insulating layer are etched, respectively, so as to expose connecting regions to be connected to an array substrate.

After formation of the connecting regions, further, the method may further include:

106, an electrical performance test is carried out on the touch electrodes.

In the embodiment, due to the fact that a transparent insulating layer is disposed additionally above and/or below the level where the touch electrodes are located, it is necessary to etch the transparent insulating layer (e.g., SiNx layer) at last, so as to expose connecting regions (pads) on the color filter substrate to be connected to an upper substrate (the array substrate). With the use of the connecting regions, the electrical performance of the touch electrode is tested, and the process of the color filter substrate ends here.

In the above embodiments, the color filter substrate is an example of a counter substrate disposed opposite to the array substrate in a display panel. If it is unnecessary to form color filter units or a black matrix on the counter substrate, then corresponding processes do not need to be performed in embodiments of the invention any more. Furthermore, in at least one embodiment of the invention, the step of forming spacers may not be included, either. In this case, the spacer may be formed on the other substrate, or the spacers are bead spacers, are disposed between two substrates of the liquid crystal cell through a spraying device.

In the manufacturing method of the touch panel provided by embodiments of the invention, an insulating layer is disposed above and/or below the level where touch electrodes are located, so as to carry out isolation of upper and lower layers that may cause problems. Thus, such an issue that short circuit and open circuit are very easy to happen to the touch electrodes during the formation is solved, and the realization of a touch function of the touch electrodes is assured successfully. It is possible that the yield is improved, and the production cost is reduced.

Experimental Verification Process

Sample preparation:

1. A pattern of a black matrix is formed by using a conventional process, and next, a touch-electrode metal layer is deposited and then subjected to photolithography by use of a negative photoresist and a KOH developing solution, so as to form touch electrodes in the shielding region of the black matrix. Touch electrodes on two samples that are formed in the above-mentioned method are labeled as touch electrodes 1 and touch electrodes 2, respectively, used as comparative examples.

2. A color filter substrate is formed by using the steps 101 to 105 as stated in the embodiment, and the touch electrode on the color filter substrate is labeled as touch electrodes 3.

A fabricating process: preparation of a black matrix is carried out on the color filter substrate; after that, deposition of SiNx is performed at a low temperature (230° C.); a preparation process for touch electrodes that includes deposition, exposing, etching and so on is carried out; an overcoat layer and spacers are formed on the color filter, including photoresist coating, exposing, developing and so on; at last, the SiNx layer is etched with a dry-etch equipment, so as to expose the connecting regions for connection with an upper substrate.

Test: the touch electrodes 1 and touch electrodes 2 as comparative examples as well as the touch electrodes 3 are measured by lead wires for R1 to R12 at an edge of the substrate.

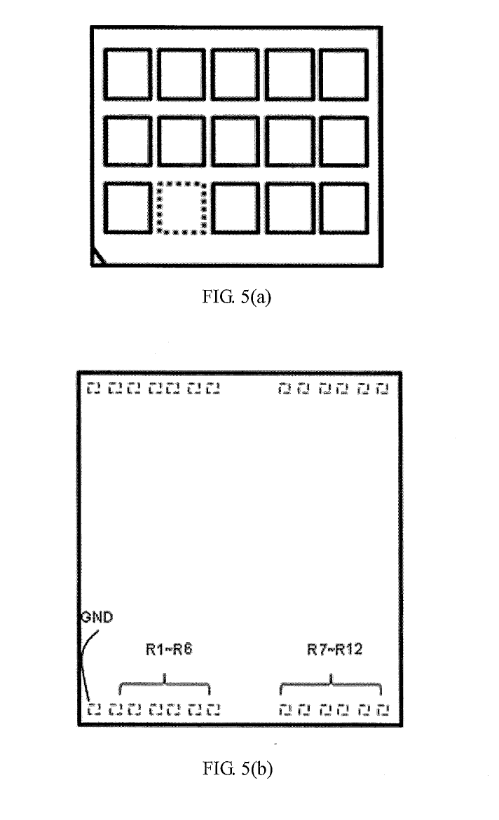

Test positions: as shown in FIG. 5(a), upon test, the color-filter surface of the color filter substrate is upward, a chamfer is on the bottom left, and a test position is denoted by a dotted area in the figure; lead wires for touch electrodes R1 to R12 at an edge of the color filter substrate upon test are shown in FIG. 5(b).

Test Method: A Probe Method (PE Probe).

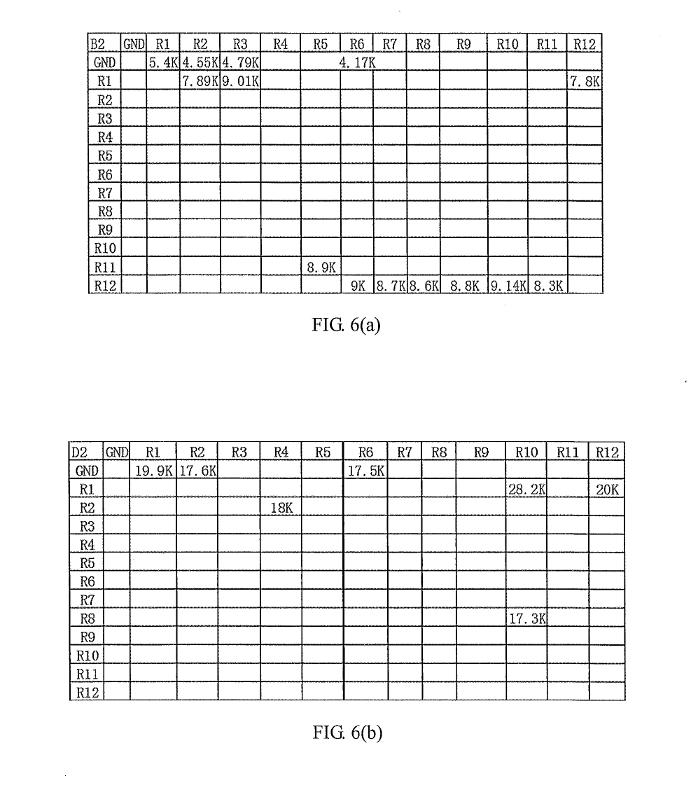

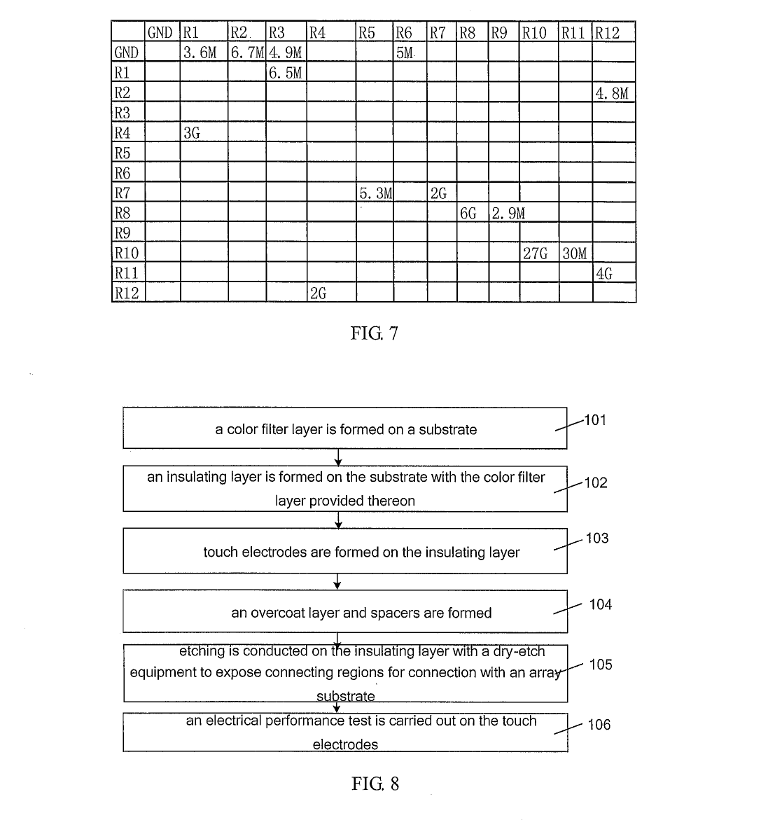

Test conclusion: as shown in FIG. 6(a) and FIG. 6(b), resistances as test results of the touch electrodes 1 and touch electrodes 2 are both on the order of K ohms, and in case of no short circuit, resistances should be above 3M. Therefore, the two groups of test data in FIG. 6(a) and FIG. 6(b) indicate that Rx1 to Rx12 in the touch electrodes 1 and touch electrodes 2 are all connected in a short-circuit way to a grounding terminal GND. As shown in FIG. 7, among test results of the touch electrodes 3, the majority of resistances are on the order of M ohms, few are on the order of G ohms, and the tested resistances are greater than or equal to 2.9M, which indicates that Rx1 to Rx12 in touch electrodes 3 are all disconnected from the grounding terminal GND. In FIG. 6(a), FIG. 6(b) and FIG. 7, R1 to R12 represent the first to twelfth touch electrodes (touch sensing lines). A transverse item entry and a vertical item entry corresponding to a measured value in figures represent lead wires connected to probes at both terminals upon resistance measurement, respectively. For example, 5.4K represents that upon test, a probe at one terminal is connected to the grounding line GND, and one terminal is connected to the first touch electrode, and this indicates that the first touch electrode is short-circuited to the grounding line GND.

In summary, with the manufacturing method of the touch panel provided by embodiments of the invention, the issue that short circuit and open circuit are very easy to occur during the course of forming touch electrodes can be avoided, and realization of a touch function of the touch electrodes is assured successfully. It is possible that the yield is improved and the production cost is reduced.

Various embodiments in the disclosure have been each described in a progressive manner, the same or similar parts in the embodiments can be mutual referenced, and what is to be emphasized in each embodiment is the difference between it and the other embodiment. Especially, in terms of a method embodiment, as it can basically refer to a device embodiment, its description is relatively simple, and the only thing to do for relevant parts is to make reference to descriptions of those parts in the method embodiment.

Descriptions made above are merely specific embodiments of the invention, but the protection scope of the invention is not limited to this. All changes or replacements, as would be readily conceived by those skilled in the art within the technical scope disclosed by the invention, shall be embraced in the protection scope of the invention. Therefore, the protection scope of the invention shall be determined by the protection scope of the claims.

This application claims the benefit of priority from Chinese patent application No. 201310553467.4, filed on Nov. 8, 2013, the disclosure of which is incorporated herein in its entirety by reference as a part of the present application.

1. A touch panel, comprising touch electrodes, wherein an insulating layer is disposed above or below the level where the touch electrodes are located, or insulating layers are respectively disposed above and below the level where the touch electrodes are located.

2. The touch panel claimed as claim wherein the insulating layer is an inorganic insulating layer.

3. The touch panel claimed as claim 2, wherein substance for the inorganic insulating layer is one or more selected from the group consisting of silicon nitride, silicon oxide, silicon oxynitride and any combination of them.

4. The touch panel claimed as claim 1, further comprising a counter substrate,
wherein the counter substrate includes a black matrix; the touch electrodes are provided on the black matrix, and are located at the shielding location of the black matrix in correspondence.

5. The touch panel claimed as claim 4, wherein the counter substrate further includes:
an overcoat layer, disposed over the touch electrodes.

6. The touch panel claimed as claim 4, wherein the counter substrate is a color filter substrate and includes a plurality of color filter units, and
wherein the plurality of color filter units are located in openings of the black matrix.

7. The touch panel claimed as claim 1, wherein the touch electrodes are touch sensing electrodes.

8. The touch panel claimed as claim 1, further comprising an array substrate, wherein the array substrate is disposed opposite to the counter substrate.

9. A manufacturing method of a touch panel, comprising forming a counter substrate, wherein forming the counter substrate comprises:
forming a black matrix on a substrate;
forming an insulating layer on the substrate with the black matrix provided thereon;
forming touch electrodes on the insulating layer; and
forming an overcoat layer.

10. The method claimed as claim 9, wherein at a temperature not higher than 230° C., a silicon nitride film layer is deposited to form the insulating layer.

11. The method claimed as claim 9, further comprising, forming a second insulating layer over the touch electrodes.

12. The method claimed as claim 9, further comprising forming spacers on the overcoat.

13. The method claimed as claim 9, further comprising, exposing a connecting region for connection with an array substrate at the level where the touch electrodes are located.

14. The method claimed as claim 13, after formation of the connecting region, further comprising:
conducting an electrical performance test on the touch electrodes.

15. A manufacturing method of a touch panel, comprising forming a counter substrate, wherein forming the counter substrate comprises:
forming a black matrix on a substrate;
forming touch electrodes;
forming an insulating layer on the substrate with the touch electrodes provided thereon;
forming an overcoat on the insulating layer.

16. The method claimed as claim 15, further comprising: forming spacers on the overcoat layer.

17. The touch panel claimed as claim 5, wherein the counter substrate is a color filter substrate and includes a plurality of color filter units, and
wherein the plurality of color filter units are located in openings of the black matrix.

18. The method claimed as claim 10, further comprising, forming a second insulating layer over the touch electrodes.

19. The method claimed as claim 10, further comprising, exposing a connecting region for connection with an array substrate at the level where the touch electrodes are located.

20. The method claimed as claim 11, further comprising, exposing a connecting region for connection with an array substrate at the level where the touch electrodes are located.
